(19) United States
(12) Patent Application Publication
(10) Pub. No.: US 2021/0294168 A1
(43) Pub. Date: Sep. 23, 2021

(54) PIXEL AND LIQUID CRYSTAL DISPLAY PANEL

(71) Applicant: TCL CHINA STAR OPTOELECTRONICS TECHNOLOGY CO., LTD., Shenzhen, Guangdong (CN)

(72) Inventor: Yani CHEN, Shenzhen, Guangdong (CN)

(21) Appl. No.: 16/759,418

(22) PCT Filed: Apr. 3, 2020
(86) PCT No.: PCT/CN2020/083109

§ 371 Date: Apr. 27, 2020

(30) Foreign Application Priority Data
Mar. 18, 2020 (CN) 202010193264.9

(51) Int. Cl. G02F 1/1362; G02F 1/1368

(52) U.S. Cl. CPC G02F 1/136286; G02F 1/136213; G02F 1/1368

(57) ABSTRACT

A pixel and a liquid crystal display are provided. The pixel includes at least one sub-pixel. Each sub-pixel includes a main sub-pixel, a first secondary sub-pixel, and a second secondary sub-pixel, which comprises three similar charging TFTs and two discharging TFTs. By using different discharging capabilities of the two discharging TFTs, it can introduce the voltage differences among the main sub-pixel, the first secondary sub-pixel and the second secondary sub-pixel. It equivalently obtains twelve display domains and thus enormously improves the viewing angle.

### FIELD OF THE INVENTION

The present invention relates to a display technique, and more particularly, to a pixel and a display panel.

### BACKGROUND OF THE INVENTION

For a vertical alignment (VA)-type of liquid crystal display (LCD) panel, the liquid crystal molecules have huge birefringence differences according to different viewing angles such that the VA-type of LCD panel has a color cast when the viewing angle is huge. Especially, a large size VA-type of LCD has a color cast in a vertical viewing angle.

As the progress of LCD panel, a VA-type of LCD having a wide viewing angle needs to be developed.

### SUMMARY OF THE INVENTION

One objective of an embodiment of the present invention is to provide a pixel and a display panel, to improve the vertical viewing angle of the huge-size LCD panel.

According to an embodiment of the present invention, a pixel is disclosed. The pixel comprises at least one sub-pixel. The sub-pixel comprises: a main sub-pixel, a first secondary sub-pixel and a second secondary sub-pixel. The main sub-pixel comprises: a first switch, having a control end electrically connected to a scan line, a first end electrically connected to a data line, and a second end electrically connected to a first node; and a first liquid crystal capacitor, electrically connected between the first node and a first common electrode. The first secondary sub-pixel comprises: a second switch, having a control end electrically connected to the scan line, a first end electrically connected to the data line and a second end electrically connected to a second node; a second liquid crystal capacitor, electrically connected between the second node and the first common electrode; and a first voltage dividing unit, electrically connected to the second node and a share electrode. The second secondary sub-pixel comprises: a third switch, having a control end electrically connected to the scan line, a first end electrically connected to the data line and a second end electrically connected to a third node; a third liquid crystal capacitor, electrically connected between the third node and the first common electrode; and a second voltage dividing unit, electrically connected to the third node and the share electrode. The first voltage dividing unit is configured to control a voltage of the second node through a voltage dividing mechanism and the second voltage dividing unit is configured to control a voltage of the third node through a voltage dividing mechanism such that the first node, the second node and the third node have different voltage levels.

According to an embodiment of the present invention, the first voltage dividing unit is a first thin film transistor (TFT) and the second voltage dividing unit is a second TFT; wherein the first TFT has a control end electrically connected to the scan line, a first end electrically connected to the second node and a second end electrically connected to the share electrode; wherein the second TFT has a control end electrically connected to the scan line, a first end electrically connected to the third node and a second end electrically connected to the share electrode; and wherein a channel width-to-channel length ratio of the first TFT is different from a channel width-to-channel length ratio of the second TFT.

According to an embodiment of the present invention, the main sub-pixel comprises a main sub-pixel electrode, the first secondary sub-pixel comprises a first secondary sub-pixel electrode, and the second secondary sub-pixel comprises a second secondary sub-pixel electrode; wherein in a same sub-pixel, the first secondary sub-pixel electrode is located between the main sub-pixel electrode and the second secondary sub-pixel electrode and the main sub-pixel electrode, the first secondary sub-pixel electrode and the second secondary sub-pixel electrode are arranged along a line; wherein the main sub-pixel electrode is electrically connected to the second end of the first switch, the first secondary sub-pixel electrode is electrically connected to the second end of the second switch, and the second secondary sub-pixel electrode is electrically connected to the second end of the third switch; and wherein the channel width-to-channel length ratio of the first TFT is less than the channel width-to-channel length ratio of the second TFT.

According to an embodiment of the present invention, two data lines are located at two opposite sides of the main sub-pixel electrode, the first secondary sub-pixel electrode and the second secondary sub-pixel electrode, the main sub-pixel electrode comprises two side electrodes extending to two opposite sides of the first secondary sub-pixel electrode and located between the two data lines and the first secondary sub-pixel electrode.

According to an embodiment of the present invention, the main sub-pixel electrode, the first secondary sub-pixel electrode and the second secondary sub-pixel electrode all have four domains.

According to an embodiment of the present invention, the share electrode and the data line are located in a same layer.

According to an embodiment of the present invention, the first switch, the second switch and the third switch are all TFTs and the first switch, the second switch and the third switch are the same.

According to an embodiment of the present invention, the first liquid crystal capacitor, the second liquid crystal capacitor and the third liquid crystal capacitor have a same capacitance.

According to an embodiment of the present invention, the sub-pixel further comprises a first storage capacitor, a second storage capacitor and a third storage capacitor; wherein the first storage capacitor is electrically connected between the first node and the second common electrode, the second storage capacitor is electrically connected between the second node and the second common electrode, and the third storage capacitor is electrically connected between the third node and the second common electrode.

According to an embodiment of the present invention, a display panel is disclosed. The display panel comprises a pixel. The pixel comprises at least one sub-pixel. The sub-pixel comprises: a main sub-pixel, a first secondary sub-pixel and a second secondary sub-pixel. The main sub-pixel comprises: a first switch, having a control end electrically connected to a scan line, a first end electrically connected to a data line, and a second end electrically connected to a first node; and a first liquid crystal capacitor, electrically connected between the first node and a first common electrode. The first secondary sub-pixel comprises: a second switch, having a control end electrically connected to the scan line, a first end electrically connected to the data line and a second end electrically connected to a second node; a second liquid crystal capacitor, electrically connected between the second node and the first common electrode; and a first voltage dividing unit, electrically connected to the second node and a share electrode. The second secondary sub-pixel comprises: a third switch, having a control end electrically connected to the scan line, a first end electrically connected to the data line and a second end electrically connected to a third node; a third liquid crystal capacitor, electrically connected between the third node and the first common electrode; and a second voltage dividing unit, electrically connected to the third node and the share electrode. The first voltage dividing unit is configured to control a voltage of the second node through a voltage dividing mechanism and the second voltage dividing unit is configured to control a voltage of the third node through a voltage dividing mechanism such that the first node, the second node and the third node have different voltage levels.

According to an embodiment of the present invention, the first voltage dividing unit is a first thin film transistor (TFT) and the second voltage dividing unit is a second TFT; wherein the first TFT has a control end electrically connected to the scan line, a first end electrically connected to the second node and a second end electrically connected to the share electrode; wherein the second TFT has a control end electrically connected to the scan line, a first end electrically connected to the third node and a second end electrically connected to the share electrode; and wherein a channel width-to-channel length ratio of the first TFT is different from a channel width-to-channel length ratio of the second TFT.

According to an embodiment of the present invention, the main sub-pixel comprises a main sub-pixel electrode, the first secondary sub-pixel comprises a first secondary sub-pixel electrode, and the second secondary sub-pixel comprises a second secondary sub-pixel electrode; wherein in a same sub-pixel, the first secondary sub-pixel electrode is located between the main sub-pixel electrode and the second secondary sub-pixel electrode and the main sub-pixel electrode, the first secondary sub-pixel electrode and the second secondary sub-pixel electrode are arranged along a line; wherein the main sub-pixel electrode is electrically connected to the second end of the first switch, the first secondary sub-pixel electrode is electrically connected to the second end of the second switch, and the second secondary sub-pixel electrode is electrically connected to the second end of the third switch; and wherein the channel width-to-channel length ratio of the first TFT is less than the channel width-to-channel length ratio of the second TFT.

According to an embodiment of the present invention, two data lines are located at two opposite sides of the main sub-pixel electrode, the first secondary sub-pixel electrode and the second secondary sub-pixel electrode, the main sub-pixel electrode comprises two side electrodes extending to two opposite sides of the first secondary sub-pixel electrode and located between the two data lines and the first secondary sub-pixel electrode.

According to an embodiment of the present invention, the main sub-pixel electrode, the first secondary sub-pixel electrode and the second secondary sub-pixel electrode all have four domains.

According to an embodiment of the present invention, the share electrode and the data line are located in a same layer.

According to an embodiment of the present invention, the first switch, the second switch and the third switch are all TFTs and the first switch, the second switch and the third switch are the same.

According to an embodiment of the present invention, the first liquid crystal capacitor, the second liquid crystal capacitor and the third liquid crystal capacitor have a same capacitance.

According to an embodiment of the present invention, the sub-pixel further comprises a first storage capacitor, a second storage capacitor and a third storage capacitor; wherein the first storage capacitor is electrically connected between the first node and the second common electrode, the second storage capacitor is electrically connected between the second node and the second common electrode, and the third storage capacitor is electrically connected between the third node and the second common electrode.

An embodiment of the present invention provides a pixel and an LCD panel. The pixel comprises at least one sub-pixel. Each sub-pixel comprises a main sub-pixel, a first secondary sub-pixel and a second secondary sub-pixel. The first sub-pixel comprises a first voltage dividing unit. The second sub-pixel comprises a second voltage dividing unit. The first voltage dividing unit controls the voltage level of the second node and the second voltage dividing unit controls the voltage level of the third node such that the first node, the second node and the third node have different voltage levels and the first LC capacitor, the second LC capacitor and the third LC capacitor have different voltages after charging operations. This makes the driving voltages for the main sub-pixel, the first secondary sub-pixel and the second secondary sub-pixel different and thus enormously improves the viewing angles of the LCD panel, especially the vertical viewing angle of the large size LCD panel. In addition, the first voltage dividing unit and the second voltage dividing unit are both connected to the share electrode. Through the voltage level of the share electrode, the voltage levels of the second node and the third node could be adjusted according to the actual demands such that the driving voltages for the first secondary sub-pixel and the second secondary sub-pixel are adjustable. Furthermore, in the same sub-pixel, the first voltage dividing unit and the second voltage dividing unit share the same share electrode. This could raise the aperture rate of the sub-pixel.

### BRIEF DESCRIPTION OF THE DRAWINGS

FIG. 1 is a diagram of a sub-pixel according to an embodiment of the present invention.

FIG. 2 is a circuit diagram of the sub-pixel shown in FIG. 1.

### DETAILED DESCRIPTION OF PREFERRED EMBODIMENTS

To help a person skilled in the art better understand the solutions of the present disclosure, the following clearly and completely describes the technical solutions in the embodiments of the present invention with reference to the accompanying drawings in the embodiments of the present invention. Apparently, the described embodiments are a part rather than all of the embodiments of the present invention. All other embodiments obtained by a person of ordinary skill in the art based on the embodiments of the present invention without creative efforts shall fall within the protection scope of the present disclosure.

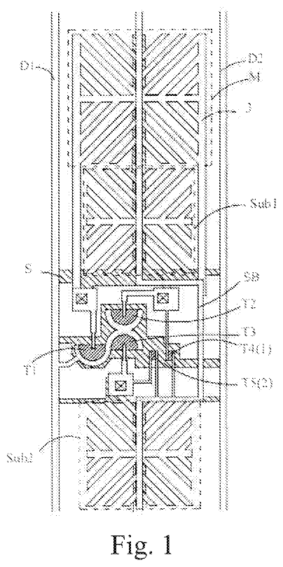

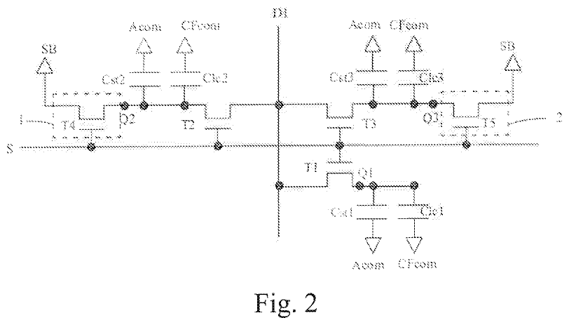

An embodiment of the present invention provides a pixel. The pixel comprises at least one sub-pixel. The sub-pixel could be a red sub-pixel, a blue sub-pixel and/or a green sub-pixel. Please refer to FIG. 1 and FIG. 2. FIG. 1 is a diagram of a sub-pixel according to an embodiment of the present invention. FIG. 2 is a circuit diagram of the sub-pixel shown in FIG. 1.

Each sub-pixel comprises a main sub-pixel, a first secondary sub-pixel and a second secondary sub-pixel. The driving voltages for the main sub-pixel, the first secondary sub-pixel and the second secondary sub-pixel are different. Therefore, the voltage difference between any two of the main sub-pixel, the first secondary sub-pixel and the second secondary sub-pixel is not zero. This allows the LCD panel having the sub-pixel to have a wider viewing angle. Especially, this improves the vertical viewing angle of the large size LCD panel.

The main sub-pixel comprises a first switch T1, a first liquid (LC) capacitor Clc1 and a first storage capacitor Cst1. The control end of the first switch T1 is electrically connected to scan line S. The first end of the first switch T1 is electrically connected to the data line D1. The second end of the first switch T1 is electrically connected to the first node Q1. The first LC capacitor Clc1 is electrically connected between the first node Q1 and the first common electrode CFcom. The first storage capacitor Cst1 is electrically connected between the first node Q1 and the second common electrode Acom. The first sub-pixel comprises a second switch T2, a first voltage dividing unit 1, a second LC capacitor Clc2 and a second storage capacitor Cst2. The control end of the second switch T2 is electrically connected to the scan line S. The first end of the second switch T2 is electrically connected to the data line D1. The second end of the second switch T2 is electrically connected to the second node Q2. The second LC capacitor Clc2 is electrically connected between the second node Q2 and the first common electrode CFcom. The second storage capacitor Cst2 is electrically connected between the second node and the second electrode Acom. The first voltage dividing unit 1 is electrically connected to the second node Q2 and the share electrode SB.

The second sub-pixel comprises a third switch T3, a second voltage dividing unit 2, a third LC capacitor Clc3 and a third storage capacitor Cst3. The control end of the third switch T3 is electrically connected to the scan line S. The first end of the third switch T3 is electrically connected to the data line D1. The second end of the third switch T3 is electrically connected to the third node Q3. The third LC capacitor Clc3 is electrically connected between the third node Q3 and the first common electrode CFcom. The third storage capacitor Cst3 is electrically connected between the third node Q3 and the second common electrode Acom. The second voltage dividing unit 2 is electrically connected between the third node Q3 and the share electrode SB.

The scan line S loads the scan signal to turn on the first switch T1, the second switch T2 and the third switch T3 such that the data line D1 sends the driving signal to the first switch T1, the second switch T2 and the third switch T3. The first voltage dividing unit 1 is used to control the voltage level of the second node Q2 through the voltage dividing mechanism and the second voltage dividing unit 2 is used to control the voltage level of the third node Q3 through the voltage dividing mechanism such that the voltage levels of the first node Q1, the second node Q2 and the third node Q3 are different. Therefore, the voltage levels of the first LC capacitor Clc1, the second LC capacitor Clc2 and the third LC capacitor Clc3 after charging operations are different. The driving voltages for the main sub-pixel, the first secondary sub-pixel and the second secondary sub-pixel are different. In other words, the three sub-pixels have voltage difference. This enormously improves the vertical viewing angle of the huge size LCD panel. Furthermore, the first voltage dividing unit 1 and the second voltage dividing unit 2 are both electrically connected to the share electrode SB. Through controlling the voltage level of the share electrode SB, the voltage levels of the second node Q2 and the third node Q3 could be adjusted according to the actual demands. Compared with those electrodes having a fixed voltage level (such as the first common electrode CFcom and the second common electrode Acom) connected to the first voltage dividing unit 1 and the second voltage dividing unit 2, the driving voltages for the first secondary sub-pixel and the second secondary sub-pixel are adjustable.

The first voltage dividing unit 1 is a thin film transistor (TFT) T4. The second voltage dividing unit 2 is a second TFT T5. The control end of the first TFT T4 is electrically connected to the scan line. The first end of the first TFT T4 is electrically connected to the second node Q2. The second end of the first TFT T4 is electrically connected to the share electrode SB. The control end of the second TFT T5 is electrically connected to the scan line. The first end of the second TFT T5 is electrically connected to the third node Q3. The second end of the second TFT T5 is electrically connected to the share electrode SB. The channel width-to-channel length ratio of the first TFT T4 is different from the channel width-to-channel length ratio of the second TFT T5. That is, the discharging capability of the first TFT T4 is different from the discharging capability of the second TFT T5. Specifically, the channel width-to-channel length ratio of the first TFT T4 is less than the channel width-to-channel length ratio of the second TFT T5. The first TFT T4 and the second TFT T5 are both poly-silicon TFT. The first ends and the second ends of the first TFT T4 and the second TFT T5 are all in a strip shape. The active layers of the first TFT T4 and the second TFT T5 are both in a rectangular shape.

The main sub-pixel comprises a main sub-pixel electrode M. The first secondary sub-pixel comprises a first secondary sub-pixel electrode Sub1. The second secondary sub-pixel comprises a second secondary sub-pixel electrode Sub2. In the same sub-pixel, the first secondary sub-pixel electrode Sub1 is located between the main sub-pixel electrode M and the second secondary sub-pixel electrode Sub2 and the main sub-pixel electrode M, the first secondary sub-pixel electrode Sub1 and the second secondary sub-pixel electrode Sub2 are arranged along a line. The first switch T1, the second switch T2, the third switch T3, the first voltage dividing unit 1 and the second voltage dividing unit 2 are located between the first secondary sub-pixel electrode Sub1 and the second secondary sub-pixel electrode Sub2 such that the aperture rate of the sub-pixel is larger. The main sub-pixel electrode M, the first secondary sub-pixel electrode Sub1 and the second secondary sub-pixel electrode Sub2 are located at the same layer. The main sub-pixel electrode M, the first secondary sub-pixel electrode Sub1 and the second secondary sub-pixel electrode Sub2 are formed through patterning the same transparent conductive layer, which is an ITO layer. The second switch T2 is positioned near the first secondary sub-pixel Sub1 to make it easier to connect the second end of the second switch T2 to the first secondary sub-pixel Sub1. The third switch T3 is positioned near the second secondary sub-pixel Sub2 to make it easier to connect the second end of the third switch T3 to the second secondary sub-pixel Sub2.

The main sub-pixel electrode M is electrically connected to the second end of the first switch. The main sub-pixel electrode M has four domains. The main sub-pixel electrode M comprises a first vertical trunk electrode, a first horizontal trunk electrode, two side electrodes 3 and a first branch electrode. The first vertical trunk electrode and a first horizontal trunk electrode cross each other and are orthogonal to each other to define four branch areas. The first branch electrode is located to the four branch areas. One end of the first branch electrode is electrically connected to the first vertical trunk electrode and/or a first horizontal trunk electrode. The other end of the first branch electrode is electrically connected to the side electrodes. The angle between the first branch electrode and the first vertical trunk electrode or the first horizontal trunk electrode is 45 degrees. The first branch electrode in the adjacent domains is symmetric based on an axis of the first vertical trunk electrode or the first horizontal trunk electrode. The two side electrodes 3 are located at the opposite sides of the first vertical trunk electrode. One of the two side electrodes 3 extends to the first switch T1 and is electrically connected to the first switch T1 through a via.

The first secondary sub-pixel electrode Sub1 is electrically connected to the second end of the second switch T2. The first secondary sub-pixel electrode Sub1 has four domains. The first secondary sub-pixel electrode Sub1 comprises a second vertical trunk electrode, a second horizontal trunk electrode and a second branch electrode. The second vertical trunk electrode and a second horizontal trunk electrode cross each other and are orthogonal to each other to define four branch areas. The second branch electrode is located to the four branch areas. One end of the second branch electrode is electrically connected to the second vertical trunk electrode and/or the second horizontal trunk electrode. The angle between the second branch electrode and the second vertical trunk electrode or the second horizontal trunk electrode is 45 degrees. The second branch electrode in the adjacent domains is symmetric based on an axis of the second vertical trunk electrode or the second horizontal trunk electrode. One of the second branch electrode extends to the second switch T2 and is electrically connected to the second switch T2 through a via.

The second secondary sub-pixel electrode Sub2 is electrically connected to the second end of the third switch T3. The second secondary sub-pixel electrode Sub2 has four domains. The second secondary sub-pixel electrode Sub2 is similar to the first secondary sub-pixel electrode Sub1 and thus further illustration is omitted here.

As shown in FIG. 1, the two data lines (the data line D1 and the data line D2) are located at two opposite sides of the main sub-pixel electrode M, the first secondary sub-pixel electrode Sub1 and the second secondary sub-pixel electrode Sub2. The two side electrodes 3 of the main sub-pixel electrode M extends to two opposite sides of the first secondary sub-pixel electrode Sub1 and located between the two data lines and the first secondary sub-pixel electrode Sub1. Here, one side electrode 3 is used to connect the main sub-pixel electrode M to the second end of the switch T1. Furthermore, the two side electrodes 3 are symmetrically positioned at the opposite sides of the first secondary sub-pixel electrode Sub1 to introduce a shielding effect. This could prevent the two data lines (the data line D1 and the data line D2) from interfering the electric field formed by the first secondary sub-pixel electrode Sub1 and the first common electrode CFcom when the two data lines are loading the data signals.

The share electrode SB and the data lines are positioned at the same layer. The share electrode SB and the data lines are obtained from patterning a second metal layer. A part of the share electrode SB is overlapped with the first vertical trunk electrode of the main sub-pixel electrode M, the second vertical trunk electrode of the first secondary sub-pixel electrode Sub1 and the third vertical trunk electrode of the second secondary sub-pixel electrode Sub2. This could not only raise the aperture rate but also prevent the voltage of the share electrode from affecting the electric field formed by the main sub-pixel electrode M, the first secondary sub-pixel electrode Sub1 and the second secondary sub-pixel electrode Sub2.

The first switch T1, the second switch T2 and the third switch T3 are all TFTs. Specifically, the first switch T1, the second switch T2 and the third switch T3 are all poly-silicon TFTs. The first ends of the first switch T1, the second switch T2 and the third switch T3 are sources. The second ends of the first switch T1, the second switch T2 and the third switch T3 are drains. The first switch T1, the second switch T2 and the third switch T3 are the same such that the first switch T1, the second switch T2 and the third switch T3 have the same channel width to channel length ratio. This means that the first switch T1, the second switch T2 and the third switch T3 have the same discharging capability. The first ends of the first switch T1, the second switch T2 and the third switch T3 are in a C shape. The active layers of the first switch T1, the second switch T2 and the third switch T3 are in a half round shape.

The first LC capacitor Clc1, the second LC capacitor Clc2 and the third LC capacitor Clc3 are the same. The first LC capacitor Clc1, the second LC capacitor Clc2 and the third LC capacitor Clc3 have the same capacitance.

The first storage capacitor Cst1, the second storage capacitor Cst2 and the third storage capacitor Cst3 are the same. The first storage capacitor Cst1, the second storage capacitor Cst2 and the third storage capacitor Cst3 have the same capacitance.

In this embodiment, the first common electrode CFcom is located on the color film substrate of the LCD panel. The second electrode Acom is located on the array substrate of the LCD panel. The first common electrode CFcom and the second electrode Acom have constant voltage levels.

In an embodiment, each sub-pixel is composed of three 4-domain sub-pixels (the main sub-pixel, the first secondary sub-pixel and the second secondary sub-pixel), which comprises three similar charging TFTs and two discharging TFTs. By using different discharging capabilities of the two discharging TFTs, it can introduce the voltage differences among the main sub-pixel, the first secondary sub-pixel and the second secondary sub-pixel. It equivalently obtains twelve display domains and thus enormously improves the viewing angle.

The present invention further provides an LCD panel. The LCD panel is a VA-type of LCD panel, which comprises the above-mentioned pixel.

Above are embodiments of the present invention, which does not limit the scope of the present invention. Any modifications, equivalent replacements or improvements within the spirit and principles of the embodiment described above should be covered by the protected scope of the invention.

What is claimed is:

1. A pixel, comprising at least one sub-pixel, wherein the sub-pixel comprises:
a main sub-pixel, comprising:
a first switch, having a control end electrically connected to a scan line, a first end electrically connected to a data line, and a second end electrically connected to a first node; and
a first liquid crystal capacitor, electrically connected between the first node and a first common electrode;
a first secondary sub-pixel, comprising:
a second switch, having a control end electrically connected to the scan line, a first end electrically connected to the data line and a second end electrically connected to a second node;
a second liquid crystal capacitor, electrically connected between the second node and the first common electrode; and
a first voltage dividing unit, electrically connected to the second node and a share electrode; and
a second secondary sub-pixel, comprising:
a third switch, having a control end electrically connected to the scan line, a first end electrically connected to the data line and a second end electrically connected to a third node;
a third liquid crystal capacitor, electrically connected between the third node and the first common electrode; and
a second voltage dividing unit, electrically connected to the third node and the share electrode;
wherein the first voltage dividing unit is configured to control a voltage of the second node through a voltage dividing mechanism and the second voltage dividing unit is configured to control a voltage of the third node through a voltage dividing mechanism such that the first node, the second node and the third node have different voltage levels.

2. The pixel of claim 1, wherein the first voltage dividing unit is a first thin film transistor (TFT) and the second voltage dividing unit is a second TFT; wherein the first TFT has a control end electrically connected to the scan line, a first end electrically connected to the second node and a second end electrically connected to the share electrode; wherein the second TFT has a control end electrically connected to the scan line, a first end electrically connected to the third node and a second end electrically connected to the share electrode; and wherein a channel width-to-channel length ratio of the first TFT is different from a channel width-to-channel length ratio of the second TFT.

3. The pixel of claim 2, wherein the main sub-pixel comprises a main sub-pixel electrode, the first secondary sub-pixel comprises a first secondary sub-pixel electrode, and the second secondary sub-pixel comprises a second secondary sub-pixel electrode; wherein in a same sub-pixel, the first secondary sub-pixel electrode is located between the main sub-pixel electrode and the second secondary sub-pixel electrode and the main sub-pixel electrode, the first secondary sub-pixel electrode and the second secondary sub-pixel electrode are arranged along a line; wherein the main sub-pixel electrode is electrically connected to the second end of the first switch, the first secondary sub-pixel electrode is electrically connected to the second end of the second switch, and the second secondary sub-pixel electrode is electrically connected to the second end of the third switch; and wherein the channel width-to-channel length ratio of the first TFT is less than the channel width-to-channel length ratio of the second TFT.

4. The pixel of claim 3, wherein two data lines are located at two opposite sides of the main sub-pixel electrode, the first secondary sub-pixel electrode and the second secondary sub-pixel electrode, the main sub-pixel electrode comprises two side electrodes extending to two opposite sides of the first secondary sub-pixel electrode and located between the two data lines and the first secondary sub-pixel electrode.

5. The pixel of claim 3, wherein the main sub-pixel electrode, the first secondary sub-pixel electrode and the second secondary sub-pixel electrode all have four domains.

6. The pixel of claim 1, wherein the share electrode and the data line are located in a same layer.

7. The pixel of claim 1, wherein the first switch, the second switch and the third switch are all TFTs and the first switch, the second switch and the third switch are the same.

8. The pixel of claim 1, wherein the first liquid crystal capacitor, the second liquid crystal capacitor and the third liquid crystal capacitor have a same capacitance.

9. The pixel of claim 1, wherein the sub-pixel further comprises a first storage capacitor, a second storage capacitor and a third storage capacitor; wherein the first storage capacitor is electrically connected between the first node and the second common electrode, the second storage capacitor is electrically connected between the second node and the second common electrode, and the third storage capacitor is electrically connected between the third node and the second common electrode.

10. A liquid crystal display panel comprising a pixel, the pixel comprising at least one sub-pixel, wherein the sub-pixel comprises:
a main sub-pixel, comprising:
a first switch, having a control end electrically connected to a scan line, a first end electrically connected to a data line, and a second end electrically connected to a first node; and
a first liquid crystal capacitor, electrically connected between the first node and a first common electrode;
a first secondary sub-pixel, comprising:
a second switch, having a control end electrically connected to the scan line, a first end electrically connected to the data line and a second end electrically connected to a second node;
a second liquid crystal capacitor, electrically connected between the second node and the first common electrode; and
a first voltage dividing unit, electrically connected to the second node and a share electrode; and
a second secondary sub-pixel, comprising:
a third switch, having a control end electrically connected to the scan line, a first end electrically connected to the data line and a second end electrically connected to a third node;
a third liquid crystal capacitor, electrically connected between the third node and the first common electrode; and
a second voltage dividing unit, electrically connected to the third node and the share electrode;
wherein the first voltage dividing unit is configured to control a voltage of the second node through a voltage dividing mechanism and the second voltage dividing unit is configured to control a voltage of the third node through a voltage dividing mechanism such that the first node, the second node and the third node have different voltage levels.

11. The liquid crystal display panel of claim 10, wherein the first voltage dividing unit is a first thin film transistor (TFT) and the second voltage dividing unit is a second TFT; wherein the first TFT has a control end electrically connected to the scan line, a first end electrically connected to the second node and a second end electrically connected to the share electrode; wherein the second TFT has a control end electrically connected to the scan line, a first end electrically connected to the third node and a second end electrically connected to the share electrode; and wherein a channel width-to-channel length ratio of the first TFT is different from a channel width-to-channel length ratio of the second TFT.

12. The liquid crystal display panel of claim 11, wherein the main sub-pixel comprises a main sub-pixel electrode, the first secondary sub-pixel comprises a first secondary sub-pixel electrode, and the second secondary sub-pixel comprises a second secondary sub-pixel electrode; wherein in a same sub-pixel, the first secondary sub-pixel electrode is located between the main sub-pixel electrode and the second secondary sub-pixel electrode and the main sub-pixel electrode, the first secondary sub-pixel electrode and the second secondary sub-pixel electrode are arranged along a line; wherein the main sub-pixel electrode is electrically connected to the second end of the first switch, the first secondary sub-pixel electrode is electrically connected to the second end of the second switch, and the second secondary sub-pixel electrode is electrically connected to the second end of the third switch; and wherein the channel width-to-channel length ratio of the first TFT is less than the channel width-to-channel length ratio of the second TFT.

13. The liquid crystal display panel of claim 12, wherein two data lines are located at two opposite sides of the main sub-pixel electrode, the first secondary sub-pixel electrode and the second secondary sub-pixel electrode, the main sub-pixel electrode comprises two side electrodes extending to two opposite sides of the first secondary sub-pixel electrode and located between the two data lines and the first secondary sub-pixel electrode.

14. The liquid crystal display panel of claim 12, wherein the main sub-pixel electrode, the first secondary sub-pixel electrode and the second secondary sub-pixel electrode all have four domains.

15. The liquid crystal display panel of claim 10, wherein the share electrode and the data line are located in a same layer.

16. The liquid crystal display panel of claim 10, wherein the first switch, the second switch and the third switch are all TFTs and the first switch, the second switch and the third switch are the same.

17. The liquid crystal display panel of claim 10, wherein the first liquid crystal capacitor, the second liquid crystal capacitor and the third liquid crystal capacitor have a same capacitance.

18. The liquid crystal display panel of claim 10, wherein the sub-pixel further comprises a first storage capacitor, a second storage capacitor and a third storage capacitor; wherein the first storage capacitor is electrically connected between the first node and the second common electrode, the second storage capacitor is electrically connected between the second node and the second common electrode, and the third storage capacitor is electrically connected between the third node and the second common electrode.
